(19) United States
(12) Patent Application Publication
(10) Pub. No.: US 2026/0025545 A1
(43) Pub. Date: Jan. 22, 2026

(54) One Touch Remote Device

(71) Applicant: Jasco Products Company, LLC, Oklahoma City, OK (US)

(72) Inventors: Stuart Komarek, Oklahoma City, OK (US); Jon Treat, Oklahoma City, OK (US); Karson Cribley, Oklahoma City, OK (US); Logan Alred, Oklahoma City, OK (US)

(21) Appl. No.: 18/778,257

(22) Filed: Jul. 19, 2024

(51) Int. Cl. H04N 21/422; G08C 17/02

(52) U.S. Cl. CPC H04N 21/42206; G08C 17/02

(57) ABSTRACT

The present invention pertains to a device which controls an electronic device from a distance. More specifically, the invention pertains to a wireless device which controls an electronic device, a television, by a transmitted signal, and the device is pre-loaded with numerical program codes. Embodiments described for the present invention comprise an IC chip, a PCB board, whereas the IC chip is mounted to the PCB board, the IC chip comprises preloaded numerical program codes which correspond to an IR function of an electronic device, the preloaded numerical program codes are configured to contain numerical program codes of one or more electronic device brands, and one or more remote control buttons correspond to a distinct electronic device brand. Alternate embodiments include a primary keypad and a secondary keypad, where the secondary keypad may be configured to be hidden by a removable cover.

### BACKGROUND OF THE INVENTION

### 1. Field of the Invention

The present invention pertains to a wireless device which controls an electronic device from a distance. More specifically, the invention pertains to a wireless device which controls an electronic device, such as a television, by means of a transmitted signal, where the device is pre-loaded with numerical program codes.

### 2. Description of the Related Art

Wireless remote controls for electronic devices, such as televisions, are commonplace. A remote-control can allow operation of an electronic device that is located out of reach for direct control. Currently, remote controls are often infrared devices which send digitally coded pulses of infrared radiation.

Often, when a remote is misplaced, no longer functions, or for any multitude of reasons, a user may purchase a universal remote, where the remote may be programmed to control different electronic device brands.

Universal remotes may control a variety of devices, including: televisions, home theater receivers, cable and satellite boxes, video consoles, streaming devices, sound bars, and CD/DVD players.

Universal remote programming may be difficult and is often a top complaint for call centers. Universal remotes may require a user to manually input numerical codes that correspond to an IR function of an electronic device. A user must often correctly read a table provided within remote packaging and extract a corresponding code for a specific television brand.

U.S. Pat. No. 8,255,697 discloses discloses a portable or embedded access device that allows authorized users access to, an access-limited apparatus, device, network or system. The access device comprises an integrated circuit providing increased security by bridging the functionality of biometrics input. The device discloses an integrated circuit being mounted on a small, printed circuit board.

### SUMMARY OF THE INVENTION

The present invention comprises a wireless remote-control device that controls an electronic device, such as a television, where the remote-control may be setup to command different electronic device brands by means of preloaded numerical program codes, loaded onto an IC chip, that are popular codes distinct to said electronic device brands.

The wireless remote-control device provides universal TV remote programming. The device is comprised of an IC chip mounted to a PCB board. The remote uses preloaded popular codes from distinct electronic device brands. The device facilitates a programming process by an initial press of a setup button, then a selection of a button that represents a brand of an electronic device, such as a television. Lastly, the setup button is pressed again. The remote inputs numerical codes that correspond to an IR function of the electronic device.

Embodiments described for the present invention comprise an IC chip, a PCB board, remote-control buttons, whereas the IC chip is mounted to the PCB board, the IC chip comprises preloaded numerical program codes which correspond to an IR function of an electronic device, the preloaded numerical program codes are configured to contain numerical program codes of one or more electronic device brands, and one or more of the remote-control buttons correspond to a distinct electronic device brand.

Alternate embodiments include a primary keypad, a secondary keypad, and the secondary keypad may be configured to be hidden by a removable cover. The secondary keypad contains the one or more remote control buttons corresponding to a distinct electronic device brand. The preloaded numerical code corresponds to a numerical code that is popular to a specific television brand at the time of the electronic device wireless remote manufacture. The removable cover, when in a closed position, physically protects a battery compartment and a secondary keypad, and prevents the secondary keypad from accidental access. A remote housing battery and secondary keypad cover detent position indention resists movement of the removable cover by providing a discontinuity in a force necessary to slide the removable cover along a removable cover housing track.

Embodiments include a method where a setup button is initially pressed, then a remote-control button is pressed to select the preloaded numerical code which corresponds to the distinct electronic brand, and finally the setup button is pressed a second time to program the electronic device wireless remote to command the electronic device.

It should be appreciated that combinations of the foregoing concepts and additional concepts discussed in greater detail below are contemplated as being part of the inventive subject matter disclosed herein. In particular, all combinations of claimed subject matter appearing at the end of this disclosure, or elsewhere herein, are contemplated as being part of the inventive subject matter.

These and other systems, methods, objects, features, and advantages of the present invention will be apparent to those skilled in the art from the following detailed description of the preferred embodiment and the drawings.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 shows a perspective view of an embodiment of a device

FIG. 2 shows a front elevational view of the embodiment of the device;

FIG. 3 shows a rear elevational of the embodiment of the device;

FIG. 4 shows a left side elevational view of the embodiment of the device;

FIG. 5 shows a right side elevational view of the embodiment of the device;

FIG. 6 shows a front elevational view of the embodiment of the device;

FIG. 7 shows a rear elevational of the embodiment of the device;

FIG. 8 shows exploded view of the embodiment of the device;

FIG. 9 shows a rear elevational view of an embodiment of a device;

FIG. 10 shows a front elevational view of the embodiment of the device;

FIG. 11 shows a perspective view of the embodiment of the device;

FIG. 12 shows a perspective view of the embodiment of the device; and

FIG. 13 shows a diagram of an embodiment of a device.

While the invention has been described in connection with certain preferred embodiments, other embodiments would be understood by one of ordinary skill in the art and are encompassed herein.

Elements with corresponding reference numerals:

| | |
|---|---|
| Wireless remote control device | 100 |
| IC chip | 2 |
| PCB board | 4 |
| Remote-control buttons | 6 |
| Preloaded numerical coded remote control buttons | 8 |
| Setup button | 10 |
| Electronic device | 12 |
| Numerical codes | 14 |
| Primary keypad | 16 |
| Secondary keypad | 18 |
| Television | 22 |
| IR emitter | 24 |
| Front housing | 26 |
| Rear housing | 28 |
| Removable cover | 32 |
| Removable cover housing track | 34 |
| Remote housing battery and secondary keypad | 36 |
| cover detent position indention | |
| Secondary detent position indention | 38 |
| Battery compartment | 40 |

### DETAIL DESCRIPTION OF THE INVENTION

The claimed subject matter is described with reference to the drawings, wherein like reference numerals are used to refer to like elements throughout. In the following description, for purposes of explanation, numerous specific details are set forth in order to provide a thorough understanding of the subject innovation.

It may be evident, however, that the claimed subject matter may be practiced without these specific details. In other instances, well-known structures and devices are shown in order to facilitate describing the subject innovation. Moreover, it is to be appreciated that the drawings may not be to scale.

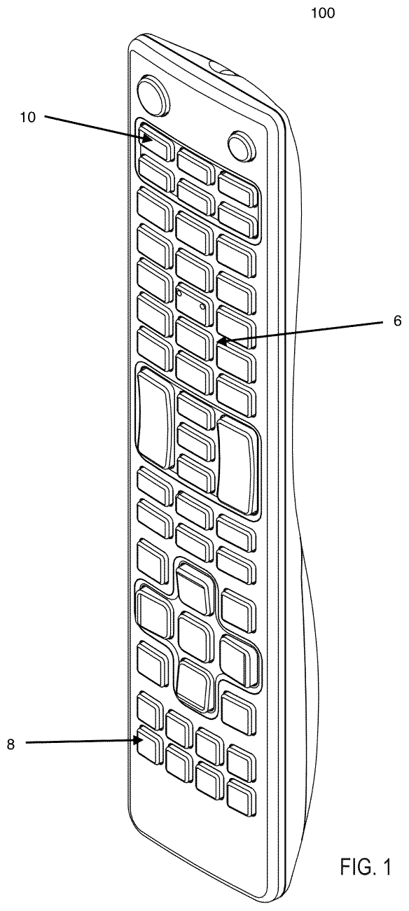

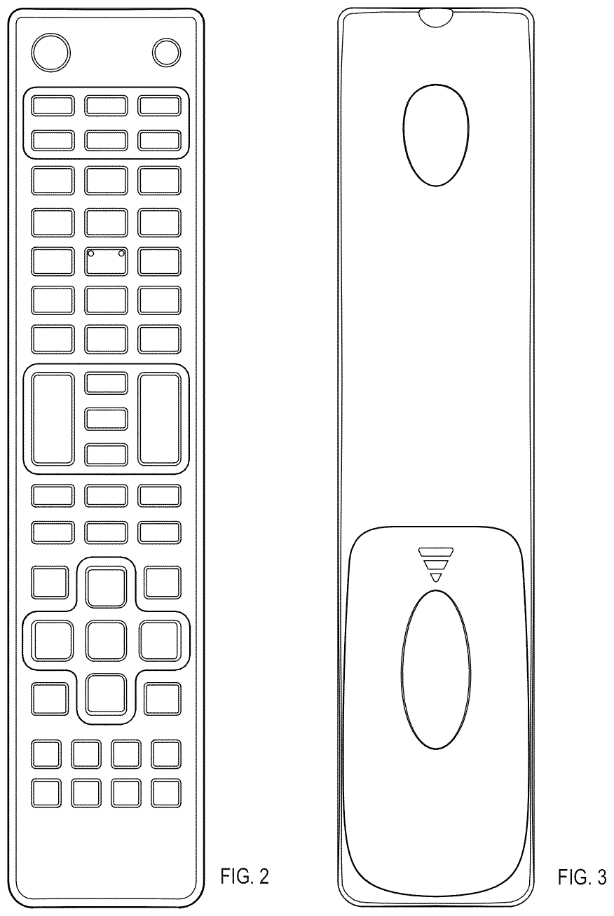

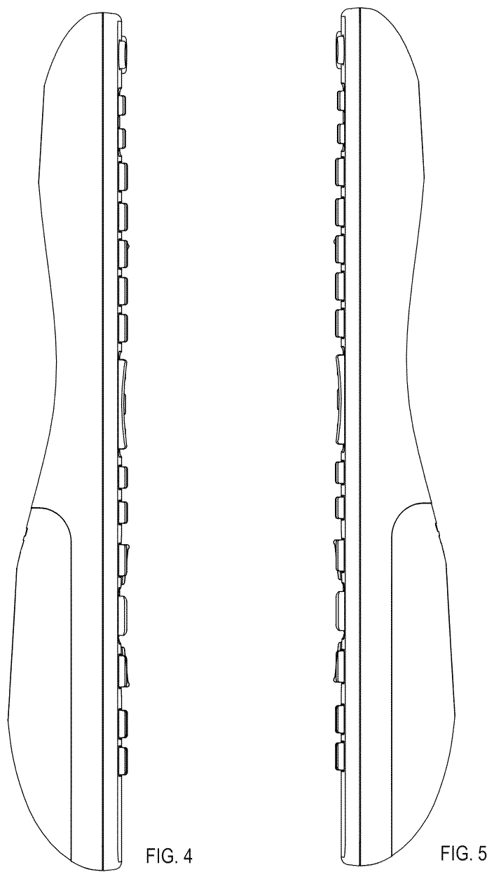

FIG. 1 shows a perspective view of an embodiment of a wireless remote-control device 100. The device may include a variety of components. In this embodiment, the device 100 comprises remote control buttons 6 configured to command an electronic device, such as a television. The device may further comprise a setup button 10. The setup button 10 is configured to begin a programming process, programming the wireless remote-control device 100 to communicate with an electronic device. The setup button 10 may be located anywhere on the device 100, thus the location relative to the remote-control buttons is not limited by the illustration.

Preloaded numerical coded remote-control buttons 8 configured to comprise popular numerical codes of electronic device brands enable a user to auto program the wireless remote-control device 100 to command the electronic device. In this embodiment, the setup button 10 is pressed to begin the programming a process, then a preloaded numerical coded remote-control button, specific to a popular brand, is pressed. Lastly, the setup button 10 is pressed a second time. The wireless remote-control device is then programmed to command the electronic device.

Embodiments of the wireless remote-control device 100 may be powered by a variety of different power sources (not shown). All power sources known to one of ordinary skill in the art are encompassed herein.

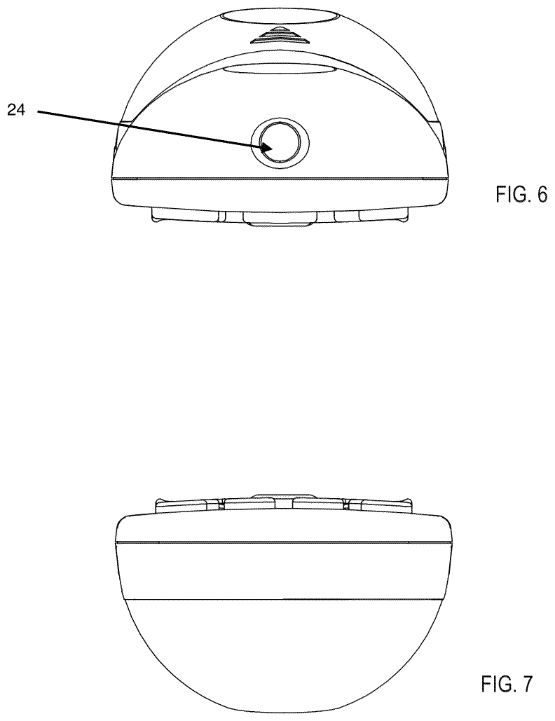

FIG. 6 shows a front elevational view of an embodiment of a wireless remote-control device 100. The device 100 comprises an IR emitter 24. The IR emitter sends digitally coded pulses of infrared radiation. Preloaded numerical codes, specific to individual electronic device brands, may be communicated by the IR emitter to an electronic device.

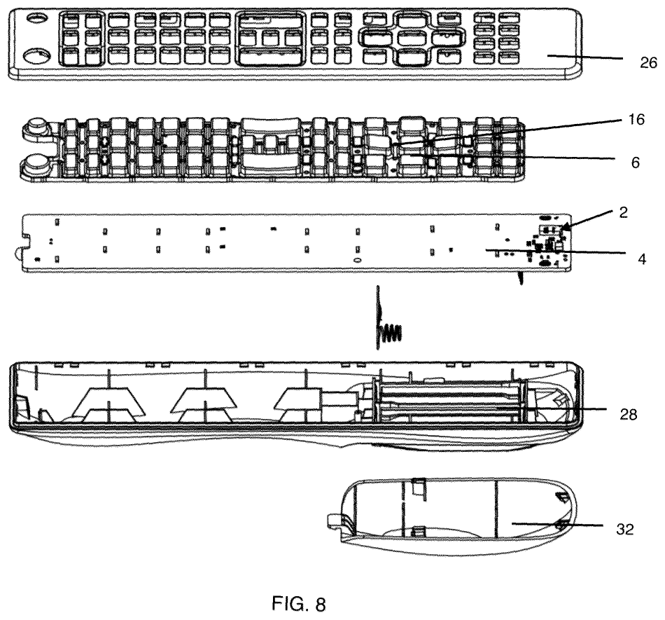

FIG. 8 shows an exploded view of an embodiment of a wireless remote-control device 100. The device comprises a front housing 26 and a rear housing 28. In this embodiment, the front housing contains apertures to facilitate access to remote control buttons 6 of a primary keypad 16. The remote-control buttons extend through the front housing 26. An IC chip 2 is mounted to a PCB board 4.

Popular numerical codes specific to individual electronic device brands are preloaded loaded onto the IC chip 2. The rear housing 28 connects to the front housing 26 to structurally support the device 100. A removable cover 32 may serve to physically protect a battery compartment (not shown) and/or serve to physically protect a secondary keypad (not shown).

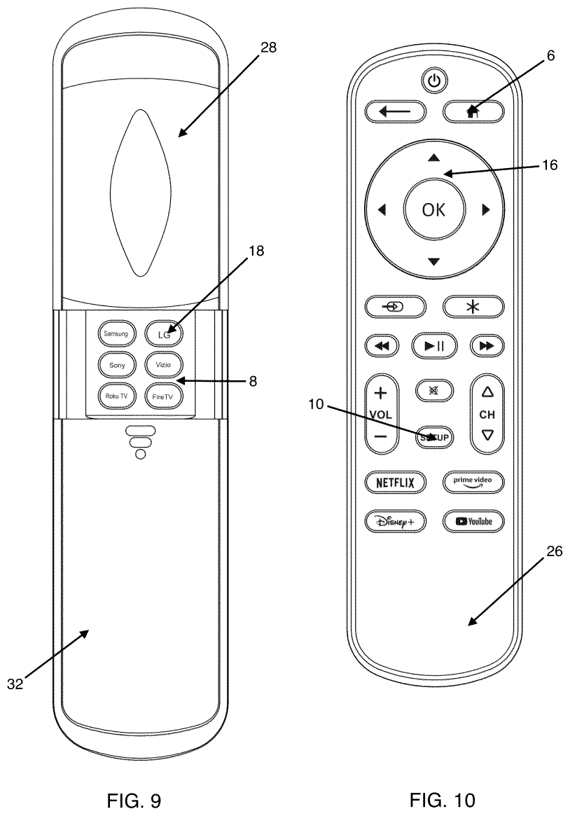

FIGS. 9 through 12 show an embodiment of a device comprised of a secondary keypad. Each figure is an alternate view of the same embodiment.

FIG. 9 shows a rear elevational view of the embodiment of a wireless remote-control device 100. A removable cover 32 physically connects to a rear housing 28 of the device 100. In this illustration, the removable cover 32 is in open position, whereas the removable cover 32 is slid along the rear housing 28, revealing the secondary keypad 18 comprised of preloaded numerical coded remote-control buttons 8.

The removable cover, when in a closed position, physically protects a battery compartment (not shown) and the secondary keypad 18, and prevents the secondary keypad comprised of preloaded numerical coded remote control buttons.

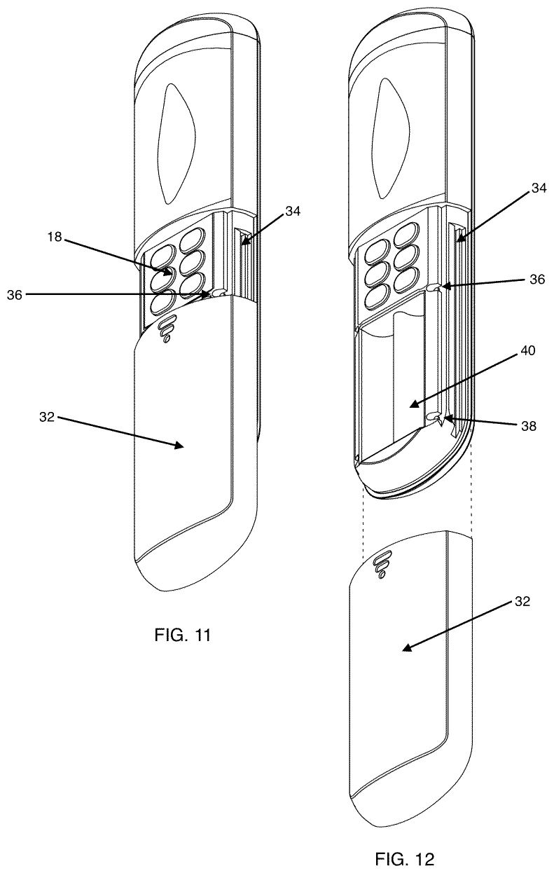

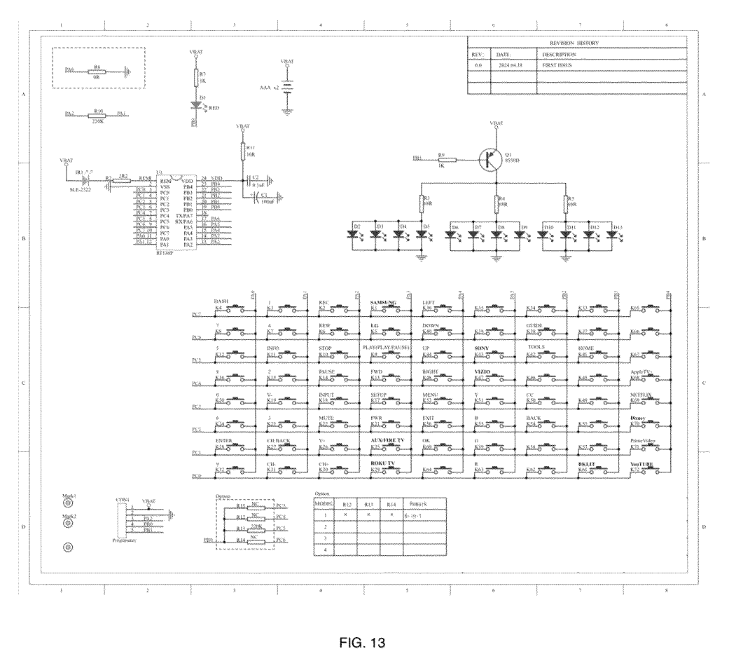

FIG. 10 shows a front elevational view of the embodiment of a wireless remote-control device 100. A primary keypad 16 comprised of remote-control buttons 6 extends through a front housing 26 of the device. In this embodiment, a setup button 10 is located on the primary keypad.

FIGS. 11 and 12 show perspective views of the embodiment of the device 100. A removable cover 32 slides along a removable cover housing track 34. The housing track is configured to create a controlled motion and range of the removable cover 32. A remote housing battery and secondary keypad cover detent position indention 36 resists movement of the removable cover by providing a discontinuity in a force necessary to slide the removable cover along a removable cover housing track.

A removable cover projecting lever extends from the interior of the removable cover. The removable cover projecting lever is configured to engage the remote housing battery and secondary keypad cover detent position indention 36 and create the discontinuity in the force necessary to slide the removable cover along the removable cover housing track 34.

The remote housing battery secondary keypad cover detent position indention 36 is configured to provide a detent position where the removable cover 32 is opened to provide access to the secondary keypad 18.

FIG. 12 shows a secondary detent position indention 38. The secondary detent position indention 38 is configured to function similar to the detent position indention 36. The indention 38 engages with the removable cover projecting lever to create a discontinuity in a force necessary to slide the removable cover along the removable cover housing track 34. The removable cover 32 is configured to provide access to a battery compartment 40 when the cover is in a secondary detent position

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. A wireless remote-control device, comprising:
an IC chip;
a PCB board;
remote-control buttons;
whereas the IC chip is mounted to the PCB board;
whereas the IC chip comprises preloaded numerical program codes which correspond to an IR function of an electronic device;
whereas the preloaded numerical program codes are configured to contain numerical program codes of one or more electronic device brands; and
whereas one or more of the remote-control buttons correspond to a distinct electronic device brand.

2. The wireless remote-control device of claim 1, further comprising:
a primary keypad;
a secondary keypad; and
whereas the secondary keypad is configured to be hidden by a removable cover.

3. The wireless remote-control device of claim 1, further comprising:
a primary keypad;
a secondary keypad; and
the secondary keypad contains the one or more remote-control buttons corresponding to a distinct electronic device brand.

4. The wireless remote-control device of claim 1, further comprising:
a primary keypad;
a secondary keypad;
whereas the secondary keypad is configured to be hidden by a removable cover; and
the secondary keypad contains the one or more remote-control buttons corresponding to a distinct electronic device brand.

5. The wireless remote-control device of claim 1, further comprising:
the electronic device comprises a television; and
the preloaded numerical code corresponds to a numerical code that communicates with a specific television brand at the time of the electronic device wireless remote manufacture.

6. A wireless remote-control device, comprising:
an IC chip;
a PCB board;
remote-control buttons;
whereas the IC chip is mounted to the PCB board;
whereas the IC chip comprises preloaded numerical program codes which correspond to an IR function of an electronic device;
whereas the preloaded numerical program codes are configured to contain numerical program codes of one or more electronic device brands;
whereas one or more of the remote-control buttons correspond to a distinct electronic device brand;
a primary keypad;
a secondary keypad;
whereas the secondary keypad is configured to be hidden by a removable cover;
the removable cover, when in a closed position, physically protects a battery compartment and a secondary keypad, and prevents the secondary keypad from accidental access;
a remote housing battery and secondary keypad cover detent position indention; and
whereas the remote housing battery and secondary keypad cover detent position indention resists movement of the removable cover by providing a discontinuity in a force necessary to slide the removable cover along a removable cover housing track.

7. The wireless remote-control device of claim 6, further comprising:
the electronic device comprises a television; and
the preloaded numerical code corresponds to a numerical code that communicates with a specific television brand at the time of the electronic device wireless remote manufacture.

8. The wireless remote-control device of claim 6, further comprising:
a removable cover projecting lever, whereas the removable cover projecting lever extends from the interior of the removable cover, and the removable cover projecting lever is configured to engage the remote housing battery and secondary keypad cover detent position indention to create the discontinuity in the force necessary to slide the removable cover along the removable cover housing track.

9. A method for programming an electronic device, wherein the method includes:
an electronic device wireless remote comprising a remote-control button located on a secondary keypad comprised of more than one remote-control buttons corresponding to distinct electronic device brands, wherein the secondary keypad is hidden by a removable cover, wherein a primary keypad is configured to be accessible and unobstructed, is pressed to select a preloaded numerical code, loaded onto an IC chip mounted to a PCB board, configured to correspond to an IR function of an electronic device; and
wherein the preloaded numerical code corresponds to a distinct electronic device brand, and the pressing of said remote-control button programs the remote to communicate with the electronic device.

10. The method of claim 9, wherein the method further comprises:
the electronic device comprises a television; and
the preloaded numerical code corresponds to a numerical code that communicates with a specific television brand at the time of the electronic device wireless remote manufacture.

11. The method of claim 9, wherein the method further comprises:
a setup button is initially pressed, then the said remote-control button is pressed to select the preloaded numerical code which corresponds to the distinct electronic brand, and finally the setup button is pressed a second time to program the electronic device wireless remote to command the electronic device.

12. The method of claim 9, wherein the method further comprises:
the electronic device comprises a television;
the preloaded numerical code corresponds to a numerical code that communicates with a specific television brand at the time of the electronic device wireless remote manufacture; and
a setup button is initially pressed, then the said remote-control button is pressed to select the preloaded numerical code which corresponds to the distinct electronic brand, and finally the setup button is pressed a second time to program the electronic device wireless remote to command the electronic device.
